(19) United States
(12) Patent Application Publication
(10) Pub. No.: US 2011/0225468 A1
(43) Pub. Date: Sep. 15, 2011

(54) STORAGE APPARATUS AND METHOD OF CONTROLLING THE SAME

(75) Inventors: Jumpei SHIMADA, Nagoya-shi (JP); Satoru Goto, Nagoya-shi (JP)

(73) Assignee: Buffalo Inc., Nagoya-shi (JP)

(21) Appl. No.: 13/046,245

(22) Filed: Mar. 11, 2011

(30) Foreign Application Priority Data
Mar. 12, 2010 (JP) 2010-055875

(51) Int. Cl. G06F 12/16; G06F 11/07

(52) U.S. Cl. 714/57; 711/114; 714/E11.025; 711/E12.103

(57) ABSTRACT

A storage apparatus in which at least a first storage medium and a second storage medium are installable and only the first storage medium is initially installed, the storage apparatus including a redundancy unit for executing a redundancy operation in which the same data is stored in both of the installed first storage medium and the second storage medium, and a controller for controlling the redundancy unit so that the redundancy unit can execute a restricted operation in which data is stored only in the first storage medium, until the second storage medium has been installed. The controller controls the redundancy unit so that the redundancy unit can return from the restricted operation to the redundancy operation after the second storage medium has been installed.

### CROSS REFERENCE TO RELATED APPLICATION

This application is based upon and claims the benefit of priority from the prior Japanese Patent Application No. 2010-055875 filed on Mar. 12, 2010; the entire contents of which are incorporated herein by reference.

### BACKGROUND OF THE INVENTION

1. Field of the Invention

The present invention relates to a storage apparatus in which plural storage media are installable, and also relates to a method of controlling the same.

2. Description of the Related Art

Techniques of redundant arrays of inexpensive disks (RAID) are widely diffused which enable the building of a highly reliable storage apparatus by use of plural storage media such as hard disk drives (HDDs) (refer to Japanese Patent Application Publication No. 2007-219703, for example). In the RAID techniques, the plural storage media are treated collectively as a single logical storage area (so-called a disk array).

RAID 1 (mirroring) is one of the RAID techniques, which stores the same data in plural storage media to implement data redundancy. With RAID 1, even when one of the storage media breaks down, the loss of data can be avoided as long as the other storage media operate normally.

Furthermore, under consideration is the shipping of a storage apparatus serving also as a RAID 1 system in which plural storage media are installable, but in which only a single storage medium is installed in order to reduce price or to avoid unwanted redundancy. In the case where such a shipping procedure is adopted, the user who has purchased the storage apparatus supposedly uses the storage apparatus without data redundancy at first, and later installs an additionally purchased storage medium in the storage apparatus to build a disk array as needed.

Note that when a disk array is newly built, storage media to constitute it need to be initialized and that the data stored in any of the storage media constituting the disk array is generally saved on another storage medium.

Accordingly, in the case of a RAID-supporting storage apparatus shipped with only a single storage medium installed therein, when a user builds a disk array in the storage apparatus in which data is already stored in the single storage medium, the user needs to save the data stored in the single storage medium on another storage medium.

In recent years, however, the amount of data storable in a storage medium has been increasing due to an increase in the capacity of storage medium such as a hard disk drive. Thus, it is not always easy to save data when a disk array is newly built .

### SUMMARY OF THE INVENTION

The present invention aims to provide a storage apparatus which can function also as a disk array even in the case where only a single storage medium is installed in the storage apparatus at the time of shipment and also to provide a method of controlling the same.

In order to solve the problems described above, the present invention has the following features.

According to a feature of the present invention, there is provided a storage apparatus (RAID-supporting NAS 100) in which at least a first storage medium (HDD 1) and a second storage medium (HDD 2) are installable and only the first storage medium is initially installed, the storage apparatus including a redundancy unit (RAID function unit 111) for executing a redundancy operation in which the same data is stored in both of the installed first storage medium and second storage medium, and a controller (system controller 112) for controlling the redundancy unit so that the redundancy unit can execute a restricted operation in which data is stored only in the first storage medium, until the second storage medium has been installed, wherein the controller controls the redundancy unit so that the redundancy unit can return from the restricted operation to the redundancy operation after the second storage medium has been installed.

According to such a feature, until the second storage medium has been installed, the controller controls the redundancy unit so that the redundancy unit can execute a restricted operation in which data is stored only in the first storage medium. In other words, the storage apparatus is purposely operated in a state equivalent to the state where a part of the disk array is lost. Then, after the second storage medium has been installed, the controller controls the redundancy unit so that that the redundancy unit can return from the restricted operation to the redundancy operation. This is not to “newly build” a disk array, but to “return (rebuild)” the disk array to the original state. Thus, the data having been already stored in the first storage medium need not be erased, and the already stored data need not be saved to another storage medium either.

According to another feature of the present invention, there is provided a storage apparatus as based on the feature of storage apparatus described above, further including a notification unit (notification unit 140) for issuing an abnormality notification to notify a user of an abnormality when data cannot be stored in at least one of the first storage medium and the second storage medium, wherein the controller disables the abnormality notification until the second storage medium has been installed and enables the abnormality notification after the second storage medium has been installed.

With such a feature, the redundancy unit is controlled so that the restricted operation can be executed in which data is stored only in the first storage medium. In other words, the storage apparatus is purposely operated in a state equivalent to the state where a part of the disk array is lost. However, such a state normally means an abnormality in the storage apparatus. For this reason, the abnormality notification is disabled in this case, so that the user is not notified of the abnormality. Then, the abnormality notification is enabled after the second storage medium has been installed. Thus, when an unintended abnormality (such as failure) occurs, the user is notified of the abnormality.

According to another feature of the present invention, there is provided a storage apparatus as based on one or more of the features of storage apparatus described above, wherein the controller controls the redundancy unit so that the redundancy unit can return from the restricted operation to the redundancy operation, when the second storage medium has been installed and a user operation has been issued to instruct the redundancy unit to return from the restricted operation to the redundancy operation.

According to such a feature, it is possible to prevent the return processing (rebuilding) from being executed against the intension of the user.

According to another feature of the present invention, there is provided a storage apparatus as based on one or more of the features of storage apparatus described above, the controller controls the notification unit so that the notification unit can issue a notification to prompt a user to perform the user operation to instruct the redundancy unit to return from the restricted operation to the redundancy operation, when the second storage medium has been installed.

According to such a feature, the controller prompts the user to perform the user operation to instruct the redundancy unit to return from the restricted operation to the redundancy operation. Thus, the user can know that the redundancy unit can be returned to the redundancy operation.

According to another feature of the present invention, there is provided a storage apparatus as based on one or more of the features of storage apparatus described above, wherein the controller controls the redundancy unit so that the redundancy unit can return from the restricted operation to the redundancy operation after the second storage medium has been initialized, and the controller controls the notification unit so that the notification unit can issue a notification to prompt a user to perform a user operation to instruct the redundancy unit to return from the restricted operation to the redundancy operation, when the second storage medium has been installed and it has been confirmed that no identification information associated with the storage apparatus is stored in the second storage medium.

According to such a feature, the return processing (rebuilding) is performed after it has been confirmed that the second storage medium has never been used in the storage apparatus. Thus, a second storage medium that has ever been used in the storage apparatus is prevented from being initialized.

According to another feature of the present invention, there is provided a storage apparatus as based on one or more of the features of storage apparatus described above, wherein the first storage medium stores setting information which is information used to check whether or not the redundancy unit is to be enabled and which is information referred to by the controller, and the setting information is changeable on the basis of the user operation.

According to such a feature, the user can selectively use the storage apparatus with or without data redundancy. Thus, the convenience of the user can be enhanced.

According to another feature of the present invention, there is provided a storage apparatus as based on one or more of the features of storage apparatus described above, further comprising a communication unit for transmitting data read out of the first storage medium or the second storage medium and for receiving data to be written into the first storage medium or the second storage medium via a network, wherein the communication unit receives information describing the detail of the user operation via the network.

According to such a feature, the storage apparatus can receive the user operation via the network. Thus, the return processing can be instructed remotely. In particular, when a network attached storage (NAS) is used as the storage apparatus according to the present invention, the communication unit for communicating with a client terminal is provided in the storage apparatus. Thus, the storage apparatus can receive an operation instruction from a remote user by use of the communication unit.

According to another feature of the present invention, there is provided a storage apparatus as based on one or more of the features of storage apparatus described above, wherein each of the redundancy unit and the controller is configured with a processor and a memory using software.

According to such a feature, each of the redundancy unit and the controller is realized in the form of software. Thus, the redundancy unit and the controller can closely cooperate with each other, thereby making it possible to easily implement the control according to the first feature.

According to another feature of the present invention, there is provided a method of controlling a storage apparatus in which at least a first storage medium and a second storage medium are installable and only the first storage medium is initially installed, the method including the steps of executing a restricted operation in which data is stored only in the first storage medium, until the second storage medium has been installed; and returning from the restricted operation to the redundancy operation in which the same data is stored in both of the installed first storage medium and the second storage medium, after the second storage medium has been installed.

According to another feature of the present invention, there is provided a control method as based on the feature of storage apparatus described above, further comprising the steps of keeping an abnormality notification disabled until the second storage medium has been installed, the abnormality notification being issued to notify a user that data cannot be stored in at least one of the first storage medium and the second storage medium; and enabling the abnormality notification after the second storage medium has been installed.

### BRIEF DESCRIPTION OF THE DRAWINGS

FIG. 1 schematically shows a communication system including a RAID-supporting NAS according to an embodiment of the present invention.

FIG. 2 is a schematic perspective view of the RAID-supporting NAS as an embodiment of the present invention.

FIG. 3A shows in block diagram the hardware configuration of the RAID-supporting NAS, and FIG. 3B shows in block diagram the software configuration of the RAID-supporting NAS.

FIG. 4A shows an example of disk setting information, and FIG. 4B shows an example of disk status information.

FIG. 5 is a flowchart for an operation of the RAID-supporting NAS according to the embodiment of the present invention.

### DESCRIPTION OF THE EMBODIMENTS

A RAID-supporting NAS as an embodiment of the present invention is described with reference to the drawings. In the drawings, the same or similar components are labeled with the same or similar reference numerals. It should be noted that the drawings are simplified representations of the actual constitution, and that the dimensions of parts are different from actual ones. Further, the same part may be different in size in different drawings.

The RAID-supporting NAS as the embodiment uses a hard disk drive (HDD) as each of storage media constituting a disk array. An optical drive or a solid-state drive (SSD) consisting of nonvolatile semiconductor memory elements may be used instead of the HDD, however.

### (1) Configuration of RAID-Supporting NAS

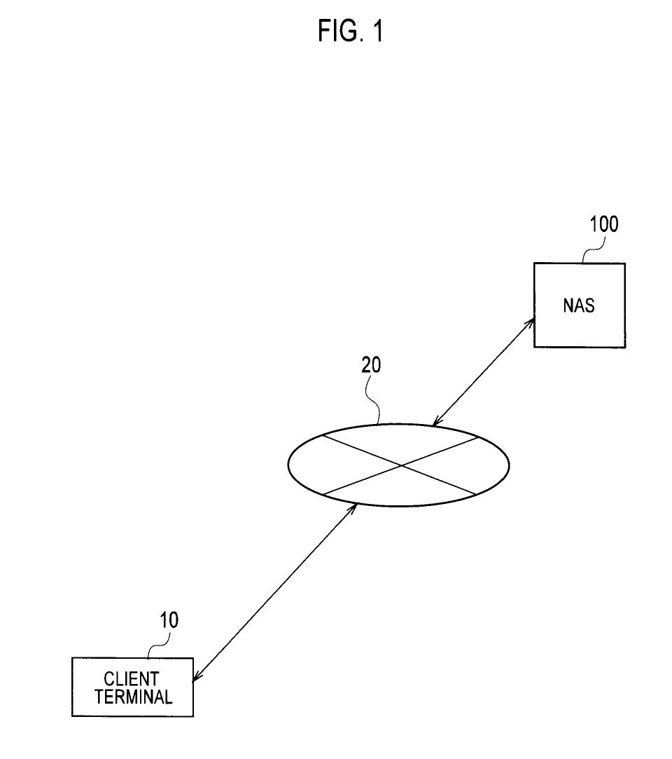

FIG. 1 schematically shows a communication system including a RAID-supporting NAS 100 according to this embodiment.

As shown in FIG. 1, the RAID-supporting NAS 100 is connected to a network 20 such as a local area network (LAN). The RAID-supporting NAS 100 functions as a RAID 1 system, in which data redundancy is secured by storing the same data in plural HDDs.

A client terminal 10 is a personal computer (PC), a network-connectable television, or the like and is connected to the network 20. The client terminal 10 performs data communications with the RAID-supporting NAS 100 via the network 20.

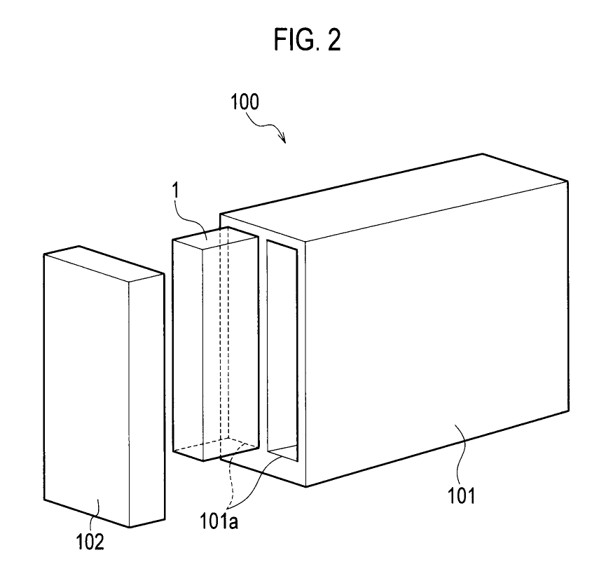

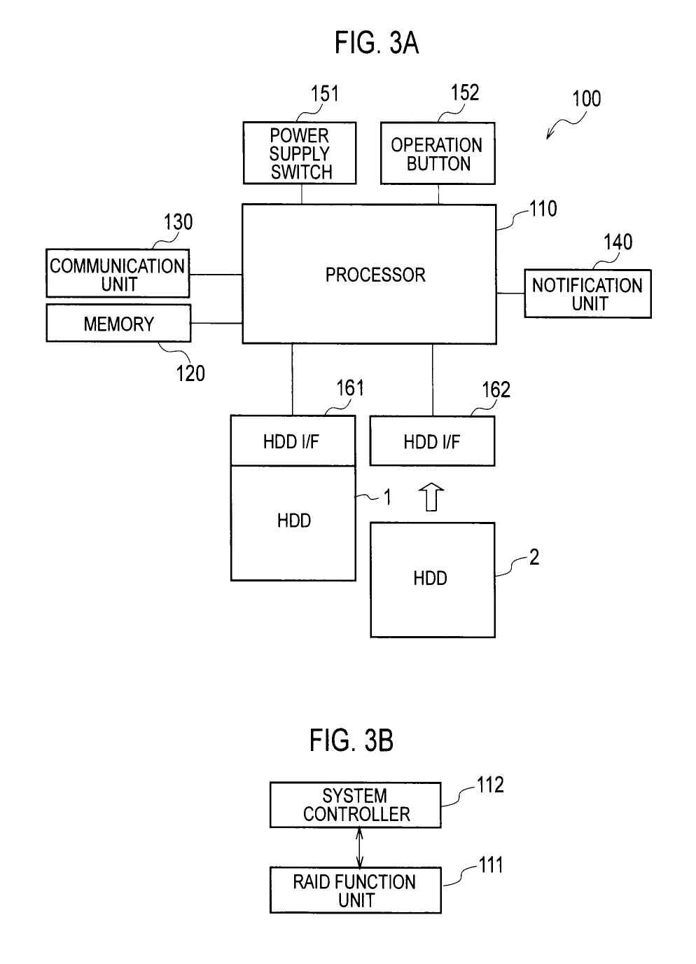

FIG. 2 is a perspective view of the RAID-supporting NAS 100. As shown in FIG. 2, the RAID-supporting NAS 100 has a main body 101 and a lid 102, and is configured in such a way that each of two HDDs, i.e. an HDD 1 and an HDD 2, (refer to FIGS. 3) can be installed into a slot 101a formed in the main body 101. Note that, FIG. 2 illustrates the RAID-supporting NAS 100 from which the lid 102 is removed, and the HDD 1 is partially drawn out.

In the initial state of the RAID-supporting NAS 100, the RAID-supporting NAS 100 only has the HDD 1 installed into the slot 101a. Here, the “initial state” means the state that the user starts using the RAID-supporting NAS 100. In this embodiment, only the HDD 1 is installed into the slot 101a in the RAID-supporting NAS 100 when the RAID-supporting NAS 100 is shipped from the factory.

The HDD 1 is in the initialized (formatted) state and previously stores therein the information used for the control and management of the RAID-supporting NAS 100. The user who has purchased the RAID-supporting NAS 100 can first store data in the HDD 1 of the RAID-supporting NAS 100 without data redundancy. Thereafter, the user can install the HDD 2 purchased additionally into the slot 101a in the RAID-supporting NAS 100 to build a disk array consisting of the two HDDs, HDD 1 and HDD 2.

### (2) Detailed Configuration of RAID-Supporting NAS

Next, detailed configurations of the RAID-supporting NAS 100 will be described with reference to FIGS. 3A and 3B.

### (2.1) Hardware Configuration

FIG. 3A is a schematic hardware configuration diagram of the RAID-supporting NAS 100.

As shown in FIG. 3A, the RAID-supporting NAS 100 comprises a processor 110, a memory 120, a communication unit 130, a notification unit 140, a power supply switch 151, an operation button 152, an HDD I/F 161 and an HDD I/F 162. The memory 120, the communication unit 130, the notification unit 140, the power supply switch 151, the operation button 152, the HDD I/F 161 and the HDD I/F 162 are electrically connected to the processor 110.

The memory 120 is a nonvolatile semiconductor memory, for example. The memory 120 stores a control program or the like, executed by the processor 110 and is used as a work area for the processor 110.

The communication unit 130 is connected to the network 20. The communication unit 130 transmits data read from the HDD 1/HDD 2 and receives data to be written into the HDD 1/HDD 2 via the network 20. The communication unit 130 receives information (command) indicating the user's operations from the client terminal 10 via the network 20.

The notification unit 140 consists of plural light emitting diodes (LEDs), for example. The notification unit 140 performs various notification operations for the user. The notifications include an abnormality notification to notify the user that data cannot be stored in at least one of the HDD 1 and the HDD 2.

The power supply switch 151 is operated by the user and used to turn ON and OFF the power supply to the RAID-supporting NAS 100. The operation button 152 is pushed by the user.

Each of the HDD I/F 161 and the HDD I/F 162 is a small computer system interface (SCSI), for example. The HDD 1 and the HDD 2 are connected to the HDD I/F 161 and the HDD I/F 162, respectively.

The processor 110 executes the control program stored in the memory 120 and controls the entire RAID-supporting NAS 100.

### (2.2) Software Configuration

FIG. 3B schematically shows the software configuration of the RAID-supporting NAS 100.

The processor 110 and the memory 120 implement the functions of a RAID function unit 111 and a system controller 112. In other words, the RAID-supporting NAS 100 serves also as a RAID 1 system by the help of the so called software RAID. To be concrete, the RAID function unit 111 executes the operation of RAID 1 in which the same data is stored in the HDD 1 and the HDD 2.

Until the HDD 2 has been installed into the slot 101a, the system controller 112 controls the RAID function unit 111 so that the RAID function unit 111 can execute the restricted operation in which data is stored only in the HDD 1. Also, the system controller 112 controls the notification unit 140 so that the abnormality notification is disabled. During the restricted operation, data redundancy is lost but data can be stored by using only the HDD 1 on the assumption that there is no trouble in the HDD 1.

The HDD 1 previously stores therein the disk setting information which is used to enable or disable the RAID function unit 111 and referred to by the system controller 112.

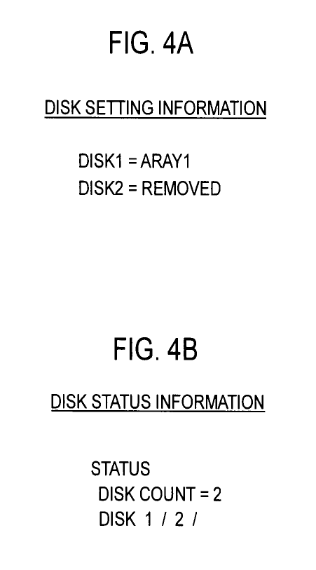

FIG. 4A shows how to interpret exemplary disk setting information. As shown in FIG. 4A, the HDD 1 (disk 1) is prepared for building a disk array for RAID 1. The HDD 2 (disk 2) is also prepared for building the disk array for RAID 1 but is currently removed from the disk array.

As described above, the RAID-supporting NAS 100 is operated in such a condition as if a part of the disk array is lost. Normally, such a state means an abnormality in the RAID-supporting NAS 100. The system controller 112, however, controls the notification unit 140 so that the abnormality notification is disabled. Thus, the user is not notified of the abnormality.

The RAID function unit 111 monitors the state of connecting the HDD 1 with the HDD I/F 161 and the state of connecting the HDD 2 with the HDD I/F 162, and manages the disk status information indicating the connection states.

FIG. 4B shows how to interpret exemplary disk status information. The example of the disk status information shown in FIG. 4B indicates that both of the HDD 1 and the HDD 2 are connected.

The system controller 112 refers to the disk status information managed by the RAID function unit 111, and after both of the HDD 1 and the HDD 2 have been connected, the system controller 112 controls the RAID function unit 111 so that the RAID function unit 111 can return from the restricted operation to the RAID 1 operation and also controls the notification unit 140 so that the abnormality notification can be enabled.

When returning from the restricted operation to the RAID 1 operation, the RAID function unit 111 initializes the HDD 2 and also copies the data stored in the HDD 1 onto the HDD 2. Thus, a RAID 1 system is rebuilt. Thereafter, the RAID function unit 111 writes data received by the communication unit 130 from the client terminal 10 into the HDD 1 and the HDD 2 simultaneously, so as to give redundancy to the data.

### (3) Operation of RAID-supporting NAS

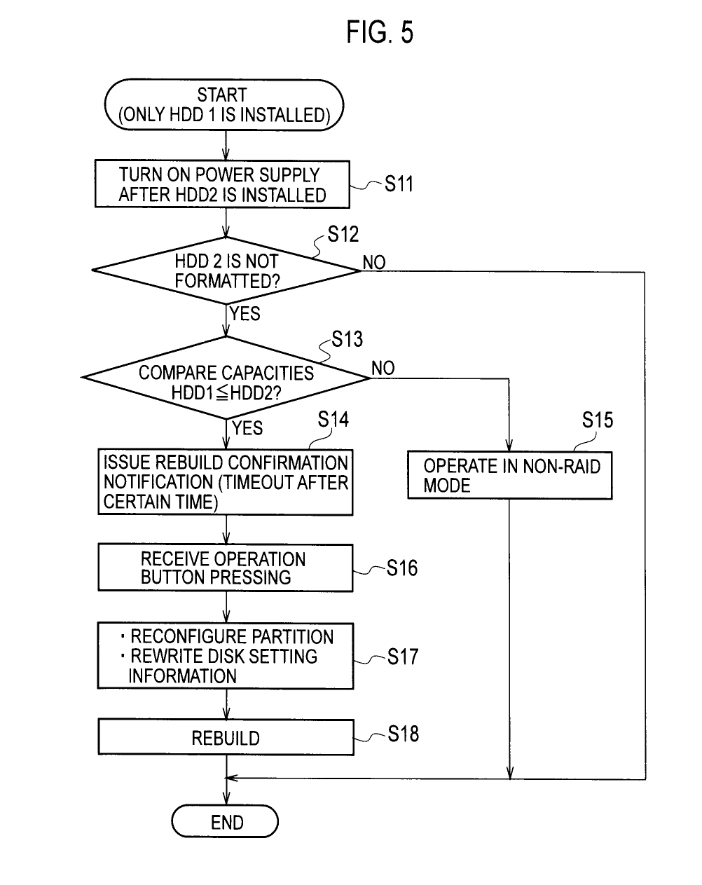

FIG. 5 is the flowchart of an operation of the RAID-supporting NAS 100. Here will be described the operation performed when the HDD 2 is installed where only the HDD 1 is already installed.

In step S11, the HDD 2 is installed into the RAID-supporting NAS 100, and the power switch 151 is turned ON.

In step S12, the system controller 112 checks whether or not the HDD 2 is formatted. In other words, the system controller 112 checks whether or not the identification information associated with the RAID-supporting NAS 100 is stored in the HDD 2.

The identification information is written into the HDD 2 when data is stored in the HDD 2. Accordingly, if the identification information does not exist in the HDD 2, this means that the HDD 2 has not yet been used in the RAID-supporting NAS 100. If the HDD 2 is not formatted yet, the processing proceeds to step S13.

In step S13, the system controller 112 acquires the storage capacity information from each of the HDD 1 and the HDD 2 and checks if the storage capacity of the HDD 2 is not less than the storage capacity of the HDD 1. If the storage capacity of the HDD 2 is not less than the storage capacity of the HDD 1, this means that the disk array can be rebuilt. Thus, the processing proceeds to step S14.

Meanwhile, if the storage capacity of the HDD 2 is less than the storage capacity of the HDD 1, the processing proceeds to step S15. In step S15, the system controller 112 updates the disk setting information to be non-RAID (normal) and then uses the HDD 1 and the HDD 2 in the non-RAID mode because RAID 1 cannot be built.

In step S14, the system controller 112 controls the notification unit 140 so that the notification unit 140 can issue notification (rebuild confirmation notification) to prompt the user to perform a user operation to instruct the RAID function unit 111 to return from the restricted operation to the RAID 1 operation. In this embodiment, one of the LEDs included in the notification unit 140 is turned on to issue the rebuild confirmation notification. This LED turns off when a preset time passes.

In step S16, when pressed by the user, the operation button 152 receives the user operation to instruct the RAID function unit 111 to return from the restricted operation to the RAID 1 operation.

In step S17, the system controller 112 initializes the HDD 2, that is, configures a partition or the like. In addition, the system controller 112 rewrites the disk setting information to be disk 2=array 2 while keeping disk 1=array 1.

In step S18, the RAID function unit 111 rebuilds RAID 1 by copying the data stored in the HDD 1 onto the HDD 2.

In this way, the shift from non-RAID to RAID 1 takes place without initializing the HDD 1.

### (4) Obtained Result

As described above, according to this embodiment, there is no need to save the data already stored in the HDD 1 to another storage medium during the operational shift from non-RAID to RAID 1. Furthermore, the abnormality notification is enabled after the HDD 2 has been installed. Thus, if an abnormality (such as a failure) occurs in the HDD 1 or the HDD 2, the user can be notified of the abnormality.

Moreover, in this embodiment, even if the HDD 2 is installed, the system controller 112 does not rebuild a RAID 1 configuration until the user operation to rebuild RAID 1 has been performed. Thus, it is possible to prevent the return processing (rebuilding) from being executed against the intension of the user.

In this embodiment, the notification is issued to prompt the user to perform the operation to rebuild a RAID 1 configuration. Thus, the user can know that the RAID-supporting NAS 100 can be returned to the RAID 1 configuration.

In this embodiment, the return processing (rebuilding) is performed after having confirmed that the HDD 2 has never been used in the RAID-supporting NAS 100 (in other words, there is no identification information associated with the RAID-supporting NAS 100). Thus, the HDD 2 that has ever been used in the RAID-supporting NAS 100 can be prevented from being initialized.

### (5) Other Embodiments

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily thought of by those skilled in the art.

The disk setting information according to the aforementioned embodiment may be so designed as to be rewritable by the client terminal 10 via the network 20. In such a case, the system controller 112 updates the disk setting information in accordance with a command received by the communication unit 130. Thus, the user can selectively use the RAID-supporting NAS 100 with or without redundancy. Hence, the convenience of the user can be enhanced.

In the aforementioned embodiment, the notification unit 140 is described as consisting of LEDs. However, a display apparatus such as a liquid crystal display or an audio output apparatus for issuing audible notification may be used instead of LEDs. Furthermore, when the notification is issued on the client terminal 10 via the network 20, the communication unit 130 forms a part of the notification unit 140.

In the aforementioned embodiment, the operation button 152 is described as being a mechanical push button, but may be a touch panel or the like as long as the touch panel or the like can be manipulated by the user.

Note that, in the aforementioned embodiments, the RAID-supporting NAS 100 is described as an embodiment of the storage apparatus of the present invention. However, the present invention is not limited to the RAID-supporting NAS 100, but applicable to other storage apparatuses such as a universal serial bus (USB) connection storage apparatus, a large file server, and a PC server.

As described above, the present invention naturally includes various embodiments not specifically described herein.

What is claimed is:

1. A storage apparatus in which at least a first storage medium and a second storage medium are installable and only the first storage medium is initially installed, the storage apparatus comprising:
a redundancy unit for executing a redundancy operation in which the same data is stored in both of the installed first storage medium and second storage medium; and
a controller for controlling the redundancy unit so that the redundancy unit can execute a restricted operation in which data is stored only in the first storage medium, until the second storage medium has been installed, wherein
the controller controls the redundancy unit so that the redundancy unit can return from the restricted operation to the redundancy operation after the second storage medium has been installed.

2. The storage apparatus according to claim 1, further comprising a notification unit for issuing an abnormality notification to notify a user of an abnormality when data cannot be stored in at least one of the first storage medium and the second storage medium, wherein
the controller disables the abnormality notification until the second storage medium has been installed and enables the abnormality notification after the second storage medium has been installed.

3. The storage apparatus according to claim 2, wherein the controller controls the redundancy unit so that the redundancy unit can return from the restricted operation to the redundancy operation, after the second storage medium has been installed and a user operation has been issued to instruct the redundancy unit to return from the restricted operation to the redundancy operation.

4. The storage apparatus according to claim 3, wherein the controller controls the notification unit so that the notification unit can issue a notification to prompt a user to perform the user operation to instruct the redundancy unit to return from the restricted operation to the redundancy operation, after the second storage medium has been installed.

5. The storage apparatus according to claim 2, wherein
the controller controls the redundancy unit so that the redundancy unit can return from the restricted operation to the redundancy operation after the second storage medium has been initialized, and
the controller controls the notification unit so that the notification unit can issue a notification to prompt a user to perform a user operation to instruct the redundancy unit to return from the restricted operation to the redundancy operation, after the second storage medium has been installed and it has been confirmed that no identification information associated with the storage apparatus is stored in the second storage medium.

6. The storage apparatus according to claim 1, wherein the first storage medium stores setting information which is information used to check whether or not the redundancy unit is to be enabled and which is information referred to by the controller, and
the setting information is changeable on the basis of a user operation.

7. The storage apparatus according to claim 3, further comprising a communication unit for transmitting data read out of the first storage medium or the second storage medium and for receiving data to be written into the first storage medium or the second storage medium via a network, wherein
the communication unit receives information describing the detail of the user operation via the network.

8. The storage apparatus according to claim 1, wherein each of the redundancy unit and the controller is realized in the form of a processor and a memory using software.

9. A method of controlling a storage apparatus in which at least a first storage medium and a second storage medium are installable and only the first storage medium is initially installed, the method comprising the steps of:
executing a restricted operation in which data is stored only in the first storage medium, until the second storage medium has been installed; and
returning from the restricted operation to a redundancy operation in which the same data is stored in both of the installed first storage medium and second storage medium, after the second storage medium has been installed.

10. The method according to claim 9, further comprising the steps of:
disabling an abnormality notification until the second storage medium has been installed, the abnormality notification being issued to notify a user that data cannot be stored in at least one of the first storage medium and the second storage medium; and
enabling the abnormality notification after the second storage medium has been installed.
